(19) United States
(12) Patent Application Publication
(10) Pub. No.: US 2025/0217432 A1
(43) Pub. Date: Jul. 3, 2025

(54) METHOD OF TASK OPTIMIZATION AND USE OF TASK OPTIMIZATION ALGORITHMS IN THE SELECTION OF RAW MATERIALS AND SEMI-FINISHED PRODUCTS

(71) Applicant: FIBRAIN spolka z ograniczona odpowiedzialnoscia, Zaczernie (PL)

(72) Inventors: Lukasz Olbrot, Rzeszow (PL); Zbigniew Gomolka, Rzeszow (PL); Boguslaw Twarog, Rzeszow (PL); Kamil Mysliwiec, Jaslo (PL); Karol Golec, Medynia Glogowska (PL)

(73) Assignee: FIBRAIN spolka z ograniczona odpowiedzialnoscia, Zaczernie (PL)

(21) Appl. No.: 18/398,345

(22) Filed: Dec. 28, 2023

(51) Int. Cl. G06F 17/11

(52) U.S. Cl. CPC G06F 17/11

(57) ABSTRACT

A method of using algorithms for optimizing tasks of selecting raw materials and semi-finished products is to optimize discrete problems. The method is distinguished from other solvers, among other things, by the fact that ALMM-Optim updates on an ongoing basis and increases the knowledge base, which is used to: store models of problems and their components, represented in ALMM technology; support the creation of models of new problems, by using the components saved (stored) in the database; store specifications of discrete optimization methods and algorithms, represented in ALMM technology; store definitions of general properties of discrete optimization problems and information about the properties that are satisfied by individual problems. The ALMM-type decision optimization technology used is an abstract structure of logical relationships, and physical implementation requires the development and implementation of dedicated optimization models and the development of real applications that can solve NP-Hard problems based on them.

### FIELD OF THE INVENTION

The subject of the invention is the development of a method and a way to use innovative algorithms for optimizing tasks of selecting raw materials and semi-finished products using ALMM-Optim (Algebraic-Logical Meta-Model), which is a unified scheme) for creating a formal record of all constraints and information about deterministic problems for which solutions can be represented as a sequence or set of decisions.

### SUMMARY OF THE INVENTION

The purpose of the method of using algorithms for optimizing tasks of selecting raw materials and semi-finished products is to optimize discrete problems. The present method is distinguished from other solvers, among other things, by the fact that ALMM-Optim updates on an ongoing basis and increases the knowledge base, which is used to: store models of problems and their components, represented in ALMM technology; support the creation of models of new problems, by using the components saved (stored) in the database; store specifications of discrete optimization methods and algorithms, represented in ALMM technology; store definitions of general properties of discrete optimization problems and information about the properties that are satisfied by individual problems. The ALMM-type decision optimization technology used is an abstract structure of logical relationships, and physical implementation requires the development and implementation of dedicated optimization models and the development of real applications that can solve NP-Hard problems based on them. A prescriptive analysis solution methodology has been used to develop and implement decision optimization models using mathematical programming and constraint logic programming.

### BRIEF DESCRIPTION OF THE DRAWINGS

The subject of the invention is shown in FIGS. 1-4, wherein:

FIG. 1 shows an example interpretation of the course of individual DOP processes;

FIG. 2 shows the structure of the ALMM-Optim intelligent system model of optimal selection of raw materials and fiber optic semi-finished products;

FIG. 3 shows the basic schematic of the process control system for optimization and optimal selection of raw materials and fiber optic semi-finished products Module (II); and

FIG. 4 shows the industrial process control schematic on the example of waste minimization in fiber optic cable production.

### DETAILED DESCROIPTION OF THE INVENTION

The essence of the process task optimization method includes the following steps:

Step 1—carried out in the module (I), which stores a library of problem models, model templates and input data acquisition: it allows the definition of a problem model in algebraic-logical terminology, where the recursive model of a discrete optimization process is a process uniquely defined by the sextuple:

DOP=(U, S, s₀, f, S_{N}, S_{G})

Step 2—realized by the module (II) consisting of two parts: problem library, which stores AL models and SR models of individual problems, as well as it contains a repository of components for creating new models and a set of problem properties, which contains general definitions of properties of processes and problems and relations linking these properties to individual problems (components) contained in the problem library, in this step (II) parallel task optimization and process monitoring is performed in the control system, which consists of the following activities:
initializing the problem data by entering the storage resource;
determining the initial state of the task s0=(x0, t0);
determining a new state;
monitoring the trajectory;
determining possible decisions for a given state;
selecting the best possible decision for a given state;
determining the transition function f: U×S→S based on the selected state;
checking if the determined state belongs to the set of inadmissible states S_{N}⊂S and if yes terminating the calculation, or if no checking if the determined state is the goal state S_{G}⊂S.

Preferably the DOP process is the set of all finite sequences \tilde{s}=(s₀, s₁. . . , sₙ) and infinite sequences \tilde{s}=(s₀, s₁. . . ) such that:
in the case of infinite sequences, for each i∈N ∪ 0 the following condition holds: there exists uᵢ∈U_{d}(sᵢ) such that sᵢ₊₁=f(uᵢ, sᵢ);
in the case of finite sequences, for each i=1,2, . . . n−1 the preceding and the additional condition hold: sₙ∈S_{G}∪ S_{N} or Uₚ(sₙ)=Ø
and also, when defining a decision is closely related to a transition function, where the properties of the transition function include elements described by:
checking whether the decision belongs to the set Uₚ(s) of decisions possible in state s;
calculating the function Δt=fₜ(u, x, t)−t;
calculating the function: fₓ: U×X×T→X.

Also preferably, all decision limitations in a given state are defined by sets of possible control decisions in state s, denoted Uₚ(s): Uₚ(s)={u∈U: (u, s)∈Dom f}, while the limitations of a generalized state defining S_{N}, are taken into account by sets of control decisions allowed in state s, denoted U_{d}(s): U_{d}(s)={u∈Uₚ(s): f(u, s)∉S_{N}.}

The ALMM system is a multi-user system and operates in client-server mode. The organization of the knowledge base will largely depend on the type of queries generated by the users of the system and the extent to which additional properties are recorded. For an established subset of problems, a number of properties are defined in ALMM terminology that are relevant for classifying problems from the point of view of suitability for selecting appropriate solution methods. The properties refer to criteria or processes P. In the case of process properties, they may refer to individual AL elements of the model, such as decision and state coordinate types, properties of sets S_{N}, S_{G}, Uₚ(s), and transition functions. Thus, the relevant properties are potential problem library module rules that link the AL elements of the model to their corresponding properties.

An important advantage of the method according to the invention lies in the unique ability of the system controlling the discrete optimization process to flexibly influence the sequence of control decisions during changes occurring in the system's resources or in the state vector structure of the given process. The task of the technology is to provide (exact or approximate) solutions to NP-hard discrete optimization problems, using the terminology of algebraic-logical description. The main idea of the proposed solution is to generate one or more optimization trajectories for task execution (including partial trajectories, if necessary). The generation of trajectories is controlled by various general methods and/or specific optimization algorithms or algorithms for finding acceptable solutions. As a solution, the system provides a decision sequence (which determines the trajectory from the initial state s₀ to the state belonging to S_{G}) or indicates that no solution has been found. The technology provides functionality for problem modeling, problem optimization, process simulation for a given decision sequence, and presentation of results (including visualization).

The advantage of the proposed technology over other systems is that the set of decisions controlling the process changes dynamically due to the algebraic-logical formula used to describe its content. The method presented in the present invention makes it possible to control the production process taking into account the minimization of waste in the production of optical fiber cables.

The presented industrial process control system makes it possible, in the general case, to run the process along a selected bundle of state trajectories when the number of tasks or the size of the sets storing the tasks is too large for the search of optimal solutions by classical methods.

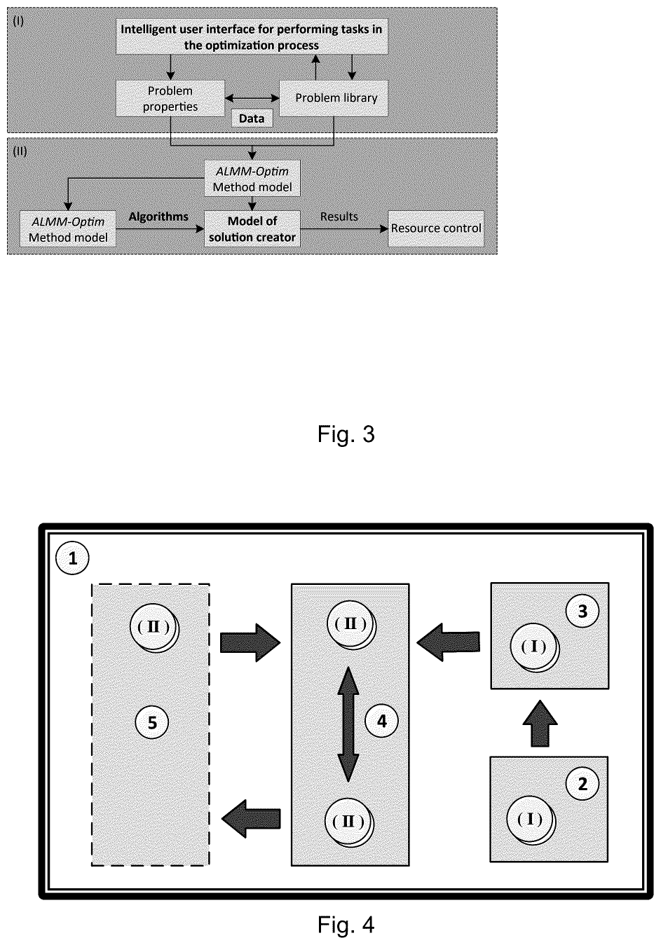

The general structure of the system shown in FIG. 3 consists of 2 main parts: data preprocessing module (I) and problem-solving module (II).

Module (I) stores a library of problem models, model templates, and input data acquisition: it allows you to define the problem model using algebraic and logical terminology. The model is defined from scratch, but it is possible to use predefined components. Predefined components are collected as database steps, which have their own attributes stored in a specific relation.

The recursive model of the discrete optimization process is a process explicitly defined by six structures:

DOP=(U, S, s₀, f, S_{N}, S_{G})
wherein:
U set of control decisions;
S=X×T set of generalized states;
X set of proper states;
T⊂ [symbol] +∪{0} subset of non-negative real numbers;
f: U×S→S partial function, transition function;
f=(fₓ, fₜ);
wherein:
fₓ: U×X×T→X next proper state;
fₜ: U×X×T→T determines the next length increment;
S₀=(x₀, t₀initial generalized state;

S_{N}⊂S set of inadmissible generalized states;

S_{G}⊂S set of goal generalized states;

S_{G} and S_{N} sets are disjoint.

Since it is not possible to precisely define formal decisions in every situation, the transition function f is defined as a partial one. Control decisions are both physical signals and decisions—there are no restrictions on the structure of the set of control decisions and states (it need not be defined in numerical space). All limitations concerning the decisions for a given state are defined by so-called sets of possible control decisions allowed in state s, denoted Up(s):

Uₚ(s)={u∈U: (u, s)∈Dom f}

Limitations concerning generalized states defining S_{N}, are taken into account by means of sets of control decisions allowed in state s, denoted U_{d}(s):

U_{d}(s)={u∈Uₚ(s):f(u, s)∉S_{N}}

The DOP process is the set of all finite sequences \tilde{s}=(s₀, s₁. . . , sₙ) and infinite sequences \tilde{s}=(s₀, s₁. . . ) such that:
in the case of infinite sequences, for each i ∈N ∪ 0, the following condition holds: there exists uᵢ∈U_{d}(sᵢ) such that sᵢ₊₁=f(uᵢ, sᵢ);
in the case of finite sequences, for each i=1,2, . . . n−1, the preceding condition and the additional condition occur: sₙ∈S_{G}∪ S_{N} or Uₚ(sₙ)=Ø.

The sequences satisfying the above conditions are called trajectories of the DOP process and are denoted by the symbol \tilde{s}, the set of all trajectories of the DOP process is denoted by the symbol \tilde{S}.

S_{E} denotes the set of generalized states for which the transition function f is indefinite, but which at the same time do not belong to the set of goal states, i.e. S_{E}={s∈S\S_{G}:Uₚ(s)=Ø}.
ũ denotes the sequence of control decisions determining the trajectory, while d(\tilde{s}) is the number of the last state of the trajectory \tilde{s} in the case of a finite trajectory. If s_{d(\tilde{s})}∈S_{G} then the trajectory is called admissible and the determined sequence of control decisions ũ is called an admissible sequence of control decisions, whereas if s_{d(\tilde{s})}∈S_{N}∪ S_{E} or the trajectory is infinite, then the trajectory is said to be inadmissible.

In the most general case, the sets U and X can be represented as Cartesian products (upper indices denote consecutive sets, not powers of sets).

U=U¹×U²×. . . ×U^{m} X=X¹×X²×. . . ×Xⁿ

In general, both the decision u and the state x are represented as n/m steps (vectors). With reference to classical control theory, we speak of state vectors and control decision vectors.

u=(u¹,u², . . . , u^{m}) x=(x¹, x², . . . , xⁿ).

Individual coordinates of the vector u represent separate decisions.

FIG. 4 shows the flow of data packets in an example of an optimization process that considers minimizing fiber waste in the production of fiber optic cables using the method described above. Incoming production tasks, such as specific orders of fiber sets, can appear in the system according to the properties of the process state vector.

In order to use the proposed technology, the following implementation of data exchange was used according to the scheduled software blocks:
\textcircled{1}—the main block responsible for controlling the raw material selection process;
\textcircled{2}—the block responsible for extracting the properties of the input data, which are necessary for the formation of the algebraic-logical description in the block \textcircled{3};
\textcircled{3}—this block is responsible for inputting the properties of the input data provided by the block \textcircled{2} to the process control system \textcircled{4}. These are the components listed in Step 1. In addition, all other components of the algorithm for the block \textcircled{3}, which are listed in the operations of Step 2, are compatible in terms of exchanging information about the properties of the process during the execution of the tasks entered in the block \textcircled{1}. The process monitoring system allows to determine the quantities dynamically (division of the problem to be solved, which is not disjoint, but must be characterized by the property of optimal substructure, into subproblems with respect to selected variables): U, S, s₀, f, S_{N}, S_{G}. These quantities are necessary for on-line determination of subsequent decisions controlling the process. The block \textcircled{5} is a supervised industrial process which, in this case, realizes the selection and optimization of optical fiber storage resources according to a specific decision sequence.

The method of process task optimization should be carried out according to the following steps:

Step 1—is performed in the module (I). The input data describing the task/process should be described using algebraic and logical terminology. Key components of the process/task should be defined.

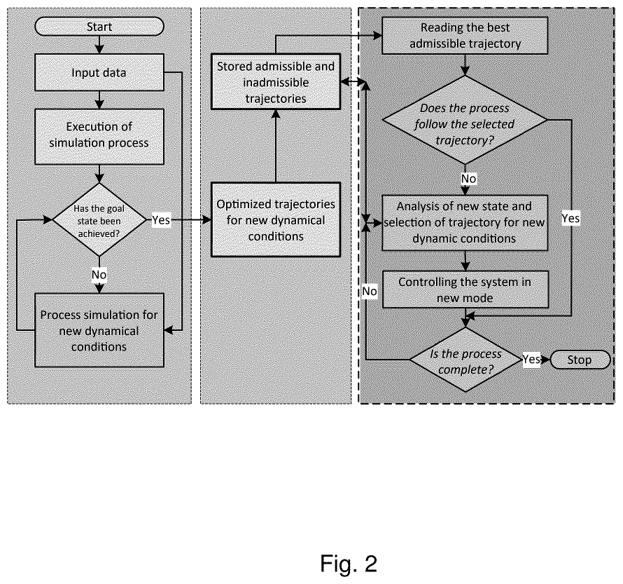

Step 2—is performed by the module (II). In this step, task optimization and process monitoring are performed in parallel in the control system. The steps of this task are connected with the following steps (the diagram of which is shown in FIG. 2):

Initialize the problem data by entering a stock resource.

Determine the initial state of the task.

Determine the new state.

Monitor the trajectory.

i) Determine the possible decisions for a given state.

ii) Select the best decision among the possible decisions for a given state.

Determine the transition function based on the state from (d).

Check if the determined state belongs to the set of inadmissible states (S_{N}—is determined on the basis of imposed conditions/limitations for the process), if yes, then finish the calculation, if no, then go to (g).

Check if the determined state is the goal state, if yes, complete the action, otherwise go to (c).

### EXAMPLE

The formal model presented in the example optimization process considering the minimization of optical fiber waste in the production of optical fiber cables using the method described above is defined as follows:

Given is a set of spools [symbol] , a function τ: [symbol] → [symbol] + that assigns respective lengths to the spools, and a function a: [symbol] → [symbol] + that determines the gain from selecting a particular set. We determine a subset of those spools that can be sequentially selected for lengths less than tₖ and such that the total gain is maximum. The set of states, the set of control decisions, and the initial state are defined as follows:
set of states X is the set of all subsets of tasks X=2 [symbol] ;
set of control decisions U is equal to the set of tasks U= [symbol] ;
set of goal states S_{G}={(x,t):x=Z}, S_{G}=S\S_{N}
set of possible control decisions Up(x)= [symbol] \x, Up(xᵢ₊₁)=Up(xᵢ)\{uᵢ},
initial state s₀=(x₀,t₀)=(Ø, 0)
transition function f:U×X×T=>X×T is defined as follows:
Uₚ(x,t)=Uₚ(x)=Z\x, therefore Uₚ(S₀)=Z
fₓ(u,x)=x∪{u}, fₜ(u,x,t)=t+τ (u)

The transition function has the following properties:

The set of possible control decisions depends only on the proper state Uₚ(s)=Uₚ(x);

The set of possible control decisions for the state xᵢ₊₁ can be calculated by a simple modification of the preceding set Uₚ(s)=Uₚ(x) Uₚ(xᵢ)=Uₚ(xᵢ)\{ᵢ};

For any s, the set of admissible control decisions U_{d}(s) is equal to the set of possible control decisions Uₚ(s). Thus, the admissible solution is any permutation of tasks.

The function fₜ does not depend directly on the state x, but only on the decision u.

The state of the process is the proper state, in addition the following properties occur:

If ũ Î Ũ, ũ=(u₁, u₂, . . . , uₙ) then the sequence of control decisions obtained by any permutation of the elements of the sequence u also belongs to Ũ;

If ũ=(u₁, u_{2,}. . . , uₙ) is an inadmissible control decision, then the sequence ũ=(u₁, u₂, . . . , uₙ₋₁) is an admissible control decision.

Module (II), which has the purpose of intelligently constructing a state transition tree (in its entirety or only a part of it) by generating one or more trajectories (parts of trajectories), stores them in the formula of ALMM-Optim technology, as well as the kernel of the computational module with the resources that control the final results.

Module (II) identifies the final solution of a given problem (best or acceptable) on the basis of data (state tree) stored in the database of algebraic-logical descriptions materialized on the disk resources of the method, generated in the process of the preparatory step. It gives the user a solution (one or more) or returns information about failure to find a solution if the solution does not exist or has not been found before the completion condition is fulfilled.

Internally, the problem library module consists of two parts: the problem library, which stores AL models and SR (Software Representation) models of individual problems and contains a repository of components for creating new models, and a set of problem properties, which contains general definitions of properties of processes and problems and the relationships linking these properties to individual problems (components) contained in the problem library.

The user interface allows you to enter a programmatic representation of the AL problem and its instance model into the solution wizard (which works with the problem model library); select the method and configuration of its solution algorithm; return a solution (one or more) or information that no solution was found. Additional information about the solution and the solution process can also be passed.

The algorithm below shows an example scenario for accessing SR or AL problem models that are stored in the problem library or that are component defined based on ALMM-Optim.

Algorithm: The main algorithm of the intelligent
user interface = \textcircled{2}, \textcircled{3}

```
Input: The kind of problem Π = (P, Q), Model
Output: Solving a given problem Π = (P, Ø)
// Π - problem, P - process, Q - criterion, LofPM - library of
// problems
// AL Model - Algebraic-logical model
// SR Model - Software representation model
  if (Π = (P, Ø)){
  connect LofPMBase( );
    if (Model ∈ LofPM) {
  switch (Model){
    case ‘AL Model’:
      Load ALModel( );
      View(Model);
      break;
    case ‘SR Model’:
      Load SRModel(ComponentsSRModel);
      Solve(Model);
      break;
    default:
      break;
  }
  else
  {
    if (ComponentsSRModel ∈ LofPM){
      DOP = new SelectComponents( );
      Model = new SRModel(DOP);
      Solve(Model);
    }
    else {
      DOP = new SelectComponents(SpecificProperties);
      Model = new SRModel(DOP);
      AddModel(LofPM);
      Solve(Model);
    }
  }
}
else {//another optimalization problem}
}
```

The solution creator module is the main computational module that performs operations to find solutions to problem occurrences. It consists of several parallel submodules called Solution Method Engines (SMEs), each based on a well-defined class of solution methods (algorithms). These methods are defined for the ALMM solver technology, i.e. a modeling paradigm and terminology based on the specifics and architecture adapted to algebraic-logic criteria.

The data entered into the model forms a knowledge base that provides a software representation of AL models for different solver modules. Features of the knowledge base are as follows:
an extensible set of computational problem models;
flexibility;
easy extensibility;
no duplication of code once written;
properties of the individual elements that define the DOP process;
properties of the trajectory of the DOP process;
properties of individual criteria.

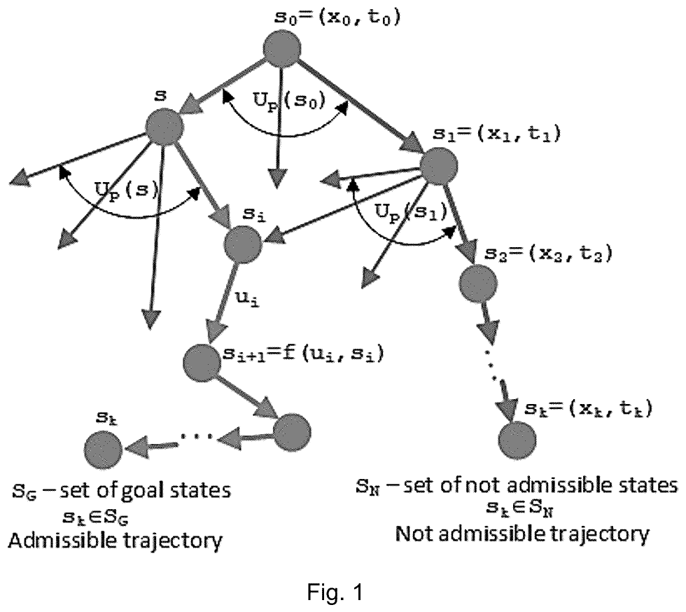

All individual DOP processes Î DOP are characterized by the same decision and state structure and the same definition of transition functions, inadmissible and goal states. An individual DOP process is represented by the set of trajectories shown in FIG. 1.

From the point of view of suitability for selecting appropriate solution methods, properties related to Q criteria or DOP processes are important for classifying problems. In the case of process properties, they may relate to individual AL elements of the model, such as decision and state coordinate types, properties of S_{N}, S_{G}, Uₚ(s) sets, and transition functions. The relevant properties must be combined with the AL elements of the model to which they apply, such as dynamically changing control decisions.

At the initial stage, the user of the system chooses a model for solving the problem by using the knowledge stored in the database or by constructing his own model of the problem. All individual processes are characterized by the same decision and state structure and the same definition of transition functions, inadmissible and goal states, which was presented in the previous part of the description. For a set of decisions U, an important property is the structure of the decision, i.e., whether it is a complex decision consisting of more than one single decision, and whether the coordinates take numerical values or symbolic names.

The way decisions are defined is closely related to the transition function. The properties of the transition function include elements described by:
checking whether a decision belongs to the set Uₚ(s) of decisions possible in state s;
computing the function Δt=fₜ(u, x, t)−t;
computing the function: fₓ: U×X×T→X.

In the set of states, one can distinguish between numerical and non-numerical coordinates. Among the non-numerical coordinates, it is necessary to distinguish between single coordinates and higher-order coordinates. The highest order of state coordinates is one of the most important features of the process. Single coordinates play different roles in the model: they are used to check the conditions defining sets of target states or inadmissible states, to determine the quantities appearing in the definition of Uₚ sets, and to calculate the values of other state coordinates or criterion values. Characteristics of how the transition function is calculated include stationarity (fₓ, Δt, Uₚdo not depend on time), how Δt is determined, monotonicity and properties, and how Uₚ(s) is determined. Considering the properties of the set S_{N}, the following cases can be distinguished: depending on the absence of limitations concerning the states stanów S_{N}=null, the limitations apply to numerical coordinates (time, raw materials) and coordinates expressed using the name variables S_{N}≠null. The set S_{G} cannot be defined as an empty set. The conditions defining it are related to a fixed end time (only applies to the t coordinate) or to a fixed set of goal states (applies only to the x coordinate). Considering the properties of the set S_{N}, the following cases can be distinguished: depending on the absence of limitations concerning the states S_{N}=Ø, the limitations are related to numerical coordinates (time, raw materials) and expressed by means of name variables S_{N}≠Ø. For any problem Π, the set S_{G} cannot be defined as an empty set. The conditions defining it are related to a fixed completion time (applies only to the t coordinate) or to a fixed set of goal states (applies only to the x coordinate). A characteristic feature of the knowledge base that is being created is that once properties are stored, they are not modified.

Below is an algorithm using the properties of the Q criterion for the application of component technology in algorithms for calculating the value of the criterion. The properties of the Q criterion include: separability, additive separability, multiplicative separability, monotonicity.

Algorithm: Selection of criterion properties Q = \textcircled{2}, \textcircled{3}

```
function criterion( ){
Domain f_{Q} = {(a, u, s) ∈ [symbol]   × U × S: s ∈ S^{P}, u ∈ U_{P}(s), a ∈ [symbol]   }
Q₀ = const
  if (Is the criterion separable){
    Qᵢ = Q(ũ′), where ũ′ = (u₀,u₂,uᵢ₋₁)
    for(i=0; d(\tilde{s})−1;i++)
      Qᵢ₊₁ = f_{Q} (Qᵢ,uᵢ,sᵢ)
  if (Is the criterion additive){
    for(i=0; d(s)−1;i++)
      f_{Q} (Qᵢ,uᵢ,sᵢ) = Qᵢ + ΔQ(uᵢ,sᵢ)
      // ΔQ(uᵢ,sᵢ) is usually denoted as ΔQᵢ
  }
  else if (Is the criterion multiplicative){
    for(i=0; d(s)−1 ;i++)
      f_{Q} (Qᵢ,uᵢ,sᵢ) = Qᵢ · q(uᵢ,sᵢ)
      //in particular q(u,s) = const
  }
  else call user function f_{Q}(Qᵢ,uᵢ,sᵢ)
}
else call user function Qᵢ₊₁ = f_{Q} (Qᵢ,uᵢ,sᵢ)
}
```

1. A method of optimization of process tasks comprising the steps of:
carried out in a module (I), which stores a library of problem models, model templates, and an input data acquisition and allows a definition of a problem model in an algebraic-logical terminology, wherein a recursive model of a discrete optimization process is a process uniquely defined by the sextuple:
DOP=(U, S, s₀, f, S_{N}, S_{G})
realized by a module (II) having two parts: a problem library, which stores AL models and SR models of individual problems, as well as contains a repository of components for creating new models and a set of problem properties, which contains general definitions of properties of processes and problems and relations linking the properties to individual problems (components) contained in the problem library;
in this step parallel task optimization and process monitoring is performed in a control system, which comprises the following activities:
initializing the problem data by entering the storage resource;
determining the initial state of the task s0=(x0, t0);
determining a new state;
monitoring the trajectory;
determining possible decisions for a given state;
selecting the best possible decision for a given state;
determining the transition function f: U×S→S based on the selected state;
checking if the determined state belongs to the set of inadmissible states S_{N}⊂S and if yes terminating the calculation, or if no checking if the determined state is the goal state S_{G}⊂S.

2. The method as claimed in claim 1, wherein the DOP process is the set of all finite sequences \tilde{s}=(s₀, s₁. . . , sₙ) and infinite sequences \tilde{s}=(s₀, s₁. . . ) such that:
in the case of infinite sequences, for each i∈N ∪ 0 the following condition holds: there exists uᵢ∈U_{d}(sᵢ) such that sᵢ₊₁=f(uᵢ, sᵢ);
in the case of finite sequences, for each i=1,2, . . . n−1 the preceding and the additional condition hold: sₙ∈S_{G}⊂ S_{N} or Uₚ(sₙ)=Ø.

3. The method as claimed in claim 1, wherein the defining a decision is closely related to a transition function, where the properties of the transition function include elements described by:
checking whether the decision belongs to the set Uₚ(s) of decisions possible in state s;
calculating the function Δt=fₜ(u, x, t)−t;
calculating the function: fₓ: U×X×T→X.

4. The method as claimed in claim 1, wherein all decision limitations in a given state are defined by sets of possible control decisions in a state s, denoted Up(s): Up(s)={u∈U: (u, s)∈Dom f}.

5. The method as claimed in claim 1, wherein the limitations of a generalized state defining S_{N}, are taken into account by sets of control decisions allowed in a state s, denoted U_{d}(s): U_{d}(s)={u∈Uₚ(s): f(u, s)∉S_{N}}.
